(19) United States
(12) Patent Application Publication
(10) Pub. No.: US 2025/0147996 A1
(43) Pub. Date: May 8, 2025

(54) SYSTEM FOR PROVIDING KOREAN SENTENCE REPHRASER SERVICE

(71) Applicant: BOOKEND INC., Daejeon (KR)

(72) Inventors: Hyun Soo CHOI, Daejeon (KR); Ji Yun PARK, Daejeon (KR); Ye Lim LEE, Daejeon (KR); Soo Yong SHIN, Seoul (KR); Yeong ll YOON, Daejeon (KR)

(73) Assignee: BOOKEND INC., Daejeon (KR)

(21) Appl. No.: 18/930,380

(22) Filed: Oct. 29, 2024

(30) Foreign Application Priority Data
Nov. 3, 2023 (KR) 10-2023-0150667

(51) Int. Cl. G06F 16/34; G06F 40/253; G10L 15/26

(52) U.S. Cl. CPC G06F 16/345; G06F 40/253; G10L 15/26

(57) ABSTRACT

Provided is a system for providing Korean sentence correction services. The system includes a user terminal that inputs a Korean sentence, selects a type corresponding to correction or generation of the Korean sentence, and outputs corrected results of the Korean sentence when the correction is selected, and a correction service providing server including a construction unit that constructs a Korean correction process using large language model (LLM)-based generative artificial intelligence (AI), a correction unit that performs correction on the Korean sentence using the generative AI when the user terminal selects the correction as the type after inputting the Korean sentence, and a transmission unit that provides the corrected results to the user terminal.

### CROSS REFERENCE TO RELATED APPLICATION

This application claims priority to Korean Patent Application No. 10-2023-0150667 filed Nov. 3, 2023, the entire contents of which are incorporated herein by reference.

### BACKGROUND

### 1. Field of the Invention

The present invention relates to a system for providing Korean sentence correction services, and more particularly, to providing a solution for correcting a Korean sentence according to tone and field after receiving the Korean sentence using a large language model (LLM)-based generative artificial intelligence (AI).

### 2. Discussion of Related Art

With the advent of ChatGPT, the era of large language models (LLMs) has begun. ChatGPT developed by OpenAI is a pretrained generative artificial intelligence (generative AI) chatbot that demonstrates excellent sentence generation performance, and has become a huge sensation, achieving 100 million monthly active users just two months after its release. An LLM is a large-scale language model that trains on vast amounts of data and has more than hundreds of billions of parameters. An LLM is trained with large-scale text data and may acquire various types of language phenomena and knowledge, and therefore an LLM may have a high understanding of natural language and also generate new sentences. In addition, an LLM may be additionally trained to deal with specific tasks and domains based on a basic language model. More parameters mean that the LLM is larger. The parameters are various variables that artificial intelligence (AI) considers for calculations, and the more parameters there are, the more information the LLM may train from data. The larger model size means that the language model may have more information, which means that the accuracy may be improved.

Methods of performing correction using big data and artificial intelligence (AI) have been studied and developed. In this regard, Korean Patent No. 10-2365345 (Published on Feb. 23, 2022) and Korean Patent No. 10-2430918 (Published on Aug. 10, 2022), which belong to the related art, disclose a configuration that collects, classifies, and processes data on words and sentences composed of text to generate standard sentence data, compares writing data input from a user terminal with standard sentence data, analyzes words and sentence structure of the writing data, and evaluates sentence errors to assign scores, and a configuration that performs Korean spelling correction to perform machine translation using a corpus composed of sentences before and after correction, respectively.

However, although Korean Patent No. 10-2365345 describes that the sentence errors are evaluated, in reality, Korean Patent No. 10-2365345 describes configuration such as spacing and spelling, and therefore does not describe a configuration for correction that changes sentences in a strict sense. Korean Patent No. 10-2430918 describes that the machine translation is performed using the corpus composed of the sentences before and after correction but describes only a configuration that transforms awkward expressions occurring during the machine translation into natural expressions and does not describe a configuration of correction that transforms Korean sentences into Korean sentences. Therefore, research and development of a solution that provides a correction process of Korean sentences using LLM-based generative AI is required.

### SUMMARY OF THE INVENTION

An embodiment of the present invention may provide a system for providing Korean sentence correction services capable of constructing a large language model (LLM)-based generative artificial intelligence (AI) to correct or generate Korean sentences, when tone and field of a sentence are specified, correcting or generating sentences to correspond to the specified tone and field, performing human-in-the-loop (HITL) machine learning using a user's correction data after storing and managing a sentence correction history, fine-tuning the LLM by using accumulated correction data, and provides the LLM as an extension program so that it may be used in an online environment. However, the technical problems to be achieved by the embodiments of the present invention are not limited to the technical problems described above, and other technical problems may exist.

As a technical means for achieving the above-described technical task, according to an embodiment of the present invention, a system for providing Korean sentence correction services includes a user terminal that inputs a Korean sentence, selects a type corresponding to correction or generation of the Korean sentence, and outputs corrected results of the Korean sentence when the correction is selected, and a correction service providing server including a construction unit that constructs a Korean correction process using a large language model (LLM)-based generative artificial intelligence (AI), a correction unit that performs correction on the Korean sentence using the generative AI when the user terminal selects the correction as the type after inputting the Korean sentence, and a transmission unit that provides the corrected results to the user terminal.

### BRIEF DESCRIPTION OF DRAWINGS

FIG. 1 is a diagram for describing a system for providing Korean sentence correction services according to an embodiment of the present invention.

FIG. 2 is a block diagram for describing a correction service providing server included in the system of FIG. 1.

FIGS. 3A to 3J and 4A to 4Q are diagrams for describing an embodiment in which Korean sentence correction services according to an embodiment of the present invention are implemented.

FIG. 5 is an operation flowchart for describing a method of providing Korean sentence correction services according to an embodiment of the present invention.

### DETAILED DESCRIPTION OF EXEMPLARY EMBODIMENTS

Hereinafter, embodiments of the present invention will be described in detail with reference to the accompanying drawings so that those skilled in the art to which the present invention pertains may easily practice the present invention. However, the present invention may be modified in various different ways and is not limited to the embodiments provided in the present description. In the accompanying drawings, portions unrelated to the description will be omitted in order to clearly describe the present invention, and similar reference numerals will be used to describe similar portions throughout the present specification.

Throughout the present specification, when one part is referred to as being “connected to” the other part, it means that the one part and the other part are “directly connected to” each other or are “electrically connected to” each other with another part interposed therebetween. Also, when any part “includes” any component, it means that other components may be further included, rather than excluding other components, unless otherwise stated, and it should be understood that it does not preclude the possibility of addition or presence of one or more other features, numbers, steps, operations, elements, parts, or combinations thereof.

The terms “about,” “substantially,” and the like used throughout the present specification represent figures corresponding to manufacturing and material tolerances specific to the stated meaning and figures close thereto and are used to prevent unconscionable abusers from unfairly using the disclosure of figures precisely or absolutely described to aid the understanding of the present invention. The term “step” or “step of”' used throughout the present specification of the present invention does not mean “step for.”

In the present specification, the term “unit” includes a unit implemented by hardware, a unit implemented by software, and a unit implemented by both hardware and software. Further, one unit may be implemented by two or more pieces of hardware, and two or more units may be implemented by one piece of hardware. However, “unit” is not limited to software or hardware, and may be configured to reside in an addressable storage medium or configured to reproduce one or more processors. Therefore, as an example, a “unit” includes components such as software components, object-oriented software components, class components and task components, processes, functions, attributes, procedures, subroutines, segments of program code, drivers, firmware, microcode, circuits, data, databases, data structures, tables, arrays, and variables. Components and functions provided within a “unit” may be combined into a smaller number of components and “units” or may be further separated into additional components and “units.” Furthermore, components and “units” may be implemented to reproduce one or more central processing units (CPUs) in a device or a security multimedia card.

In the present specification, some operations or functions described as performed by a terminal, an apparatus, or a device may be performed instead in a server connected to the corresponding terminal, apparatus, or device. Similarly, some of the operations or functions described as being performed by a server may be performed in a terminal, an apparatus, or a device connected to the corresponding server.

In the present specification, some operations or functions described as mapping with or matching a terminal may map with or match a unique number of the terminal or personal identification information, which is identification data of the terminal.

Hereinafter, the present invention will be described in detail with reference to the accompanying drawings.

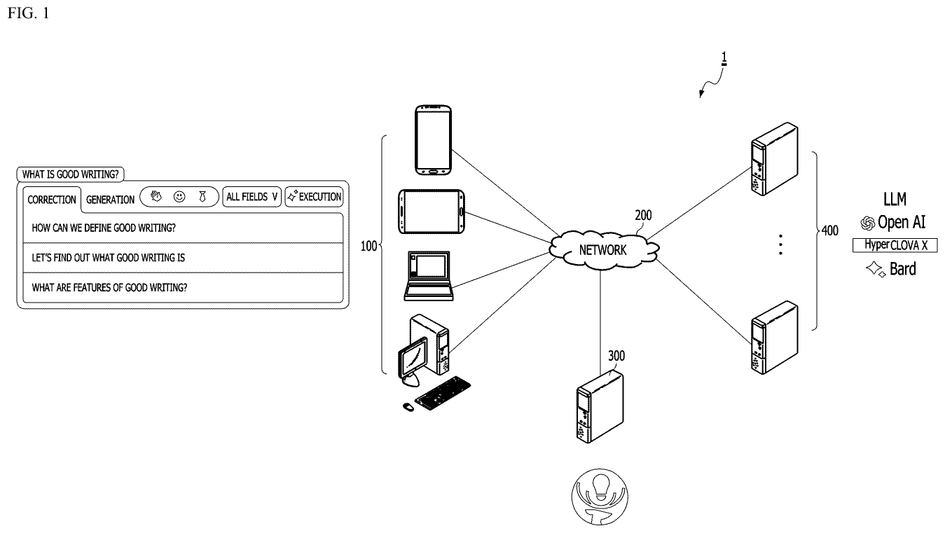

FIG. 1 is a diagram for describing a system for providing Korean sentence correction services according to an embodiment of the present invention. Referring to FIG. 1, a system 1 for providing Korean sentence correction services may include at least one user terminal 100, a correction service providing server 300, and at least one model providing server 400. However, since the system 1 for providing Korean sentence correction services of FIG. 1 is only an embodiment of the present invention, the present invention should not be limitedly interpreted through FIG. 1.

In this case, each component of FIG. 1 is generally connected through a network 200. For example, as illustrated in FIG. 1, at least one user terminal 100 may be connected to the correction service providing server 300 through a network 200. In addition, the correction service providing server 300 may be connected to at least one user terminal 100 and at least one model providing server 400 through the network 200. Additionally, at least one model providing server 400 may be connected to the correction service providing server 300 via the network 200.

Here, the network is a connection structure in which information exchange is possible between respective nodes, such as a plurality of terminals and servers, and examples of such a network include a local area network (LAN), a wide area network (WAN), the Internet (World Wide Web (WWW)), wired and wireless data communication networks, telephone networks, wired and wireless television networks, and the like. Examples of the wireless data communication network include 3G, 4G, 5G, 3^{rd} Generation Partnership Project (3GPP), 5^{th} Generation Partnership Project (5GPP), 5G new radio (5G NR), 6th Generation of Cellular Networks, Long Term Evolution (LTE), World Interoperability for Microwave Access (WiMAX), Wi-Fi, the Internet, a LAN, a wireless LAN (WLAN), a WAN, a personal area network (PAN), radio frequency (RF), a Bluetooth network, a near-field communication (NFC) network, a satellite broadcast network, an analog broadcast network, a Digital Multimedia Broadcasting (DMB) network, and the like, but are not limited thereto.

In the following, the term “at least one” is defined as including the singular and plural, and even if the term “at least one” is not present, each component may be present in singular or plural, and it will be obvious that it may mean singular or plural. In addition, whether each component is provided in singular or plural can be changed according to embodiments.

The at least one user terminal 100 may be a user terminal that inputs Korean sentences using a Korean sentence correction service-related web page, app page, program or application, and sets tone and field to request correction or generation. In this case, the user may be an individual or a company, the individual may be a student writing an essay or a report, and the company may be a company conducting correction for publishing a book.

Here, the at least one user terminal 100 may be implemented as a computer capable of accessing a server or a terminal at a remote location through a network. Here, the computer may include, for example, a navigation device, a notebook equipped with a web browser, a desktop, a laptop, and the like. In this case, the at least one user terminal 100 may be implemented as a terminal capable of accessing a server or a terminal at a remote location through a network. The at least one user terminal 100 is a mobile communication device in which portability and mobility are guaranteed, and examples thereof may include all types of handheld-based wireless communication devices such as a Personal Communication System (PCS), Global System for Mobile Communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), a Wireless Broadband (WiBro) Internet terminal, a smartphone, a smartpad, a tablet PC, and the like.

The correction service providing server 300 may be a server that provides the Korean sentence correction services-related web page, app page, program, or application. In addition, the correction service providing server 300 may be a server that constructs generative artificial intelligence (AI) using a large language model (LLM) of the at least one model providing server 400 and performs correction or generation for Korean sentences. The correction service providing server 300 may be a server that constructs a database and fine-tunes the LLM according to the correction data of the user terminal 100.

Here, the correction service providing server 300 may be implemented as a computer capable of accessing a remote server or terminal through a network. Here, the computer may include, for example, a navigation device, a notebook equipped with a web browser, a desktop, a laptop, and the like.

The at least one model providing server 400 may be a server that provides the LLM using or without using the Korean sentence correction services-related web page, app page, program or application. Here, the at least one model providing server 400 may be implemented as a computer capable of accessing a remote server or terminal through a network. Here, the computer may include, for example, a navigation device, a notebook equipped with a web browser, a desktop, a laptop, and the like.

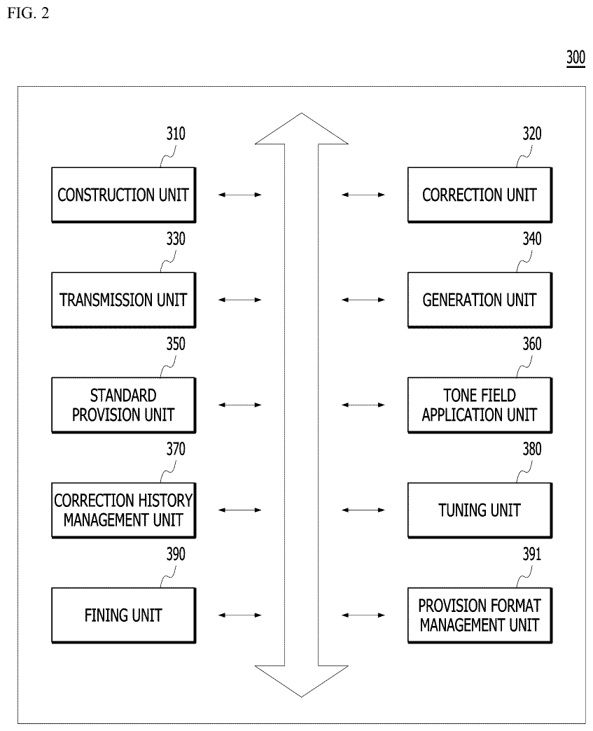

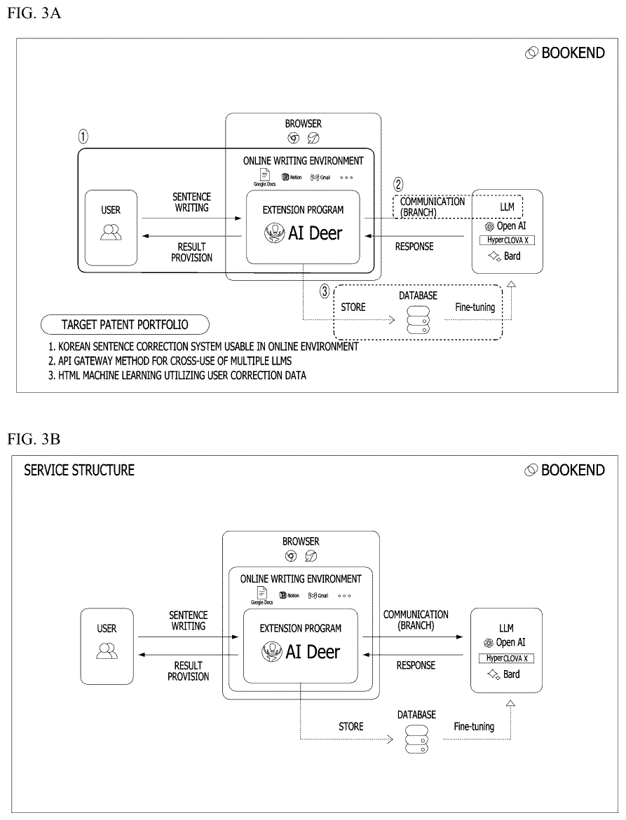

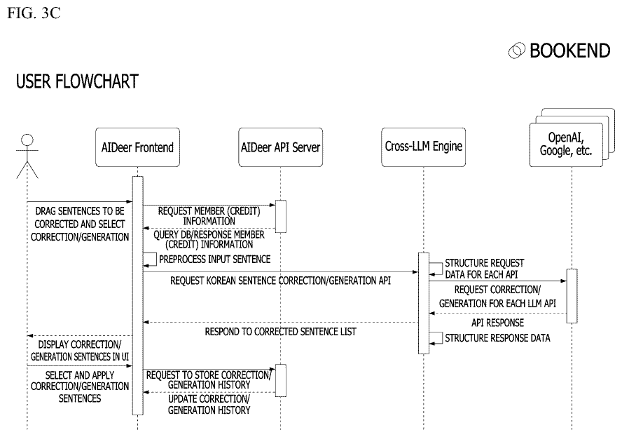

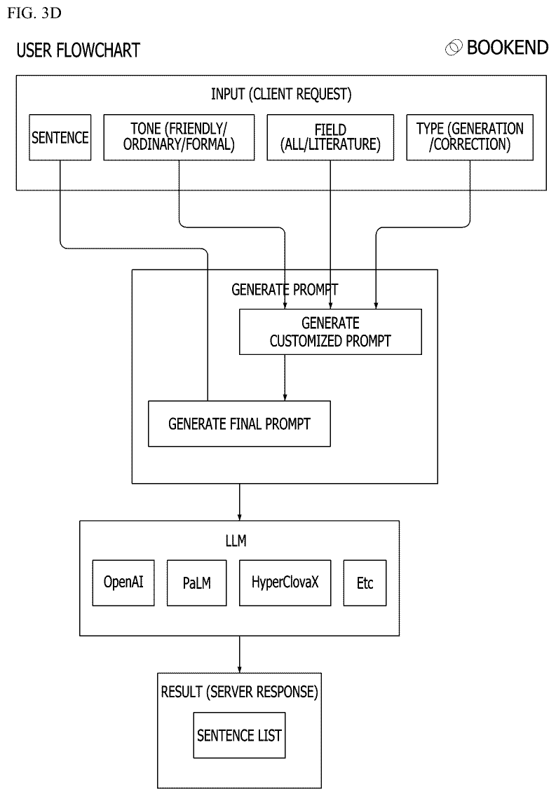

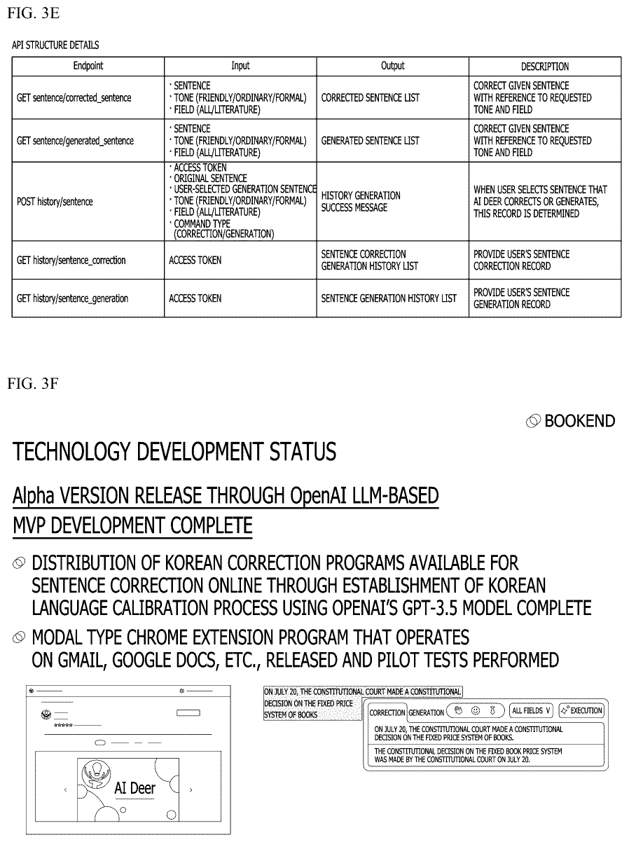

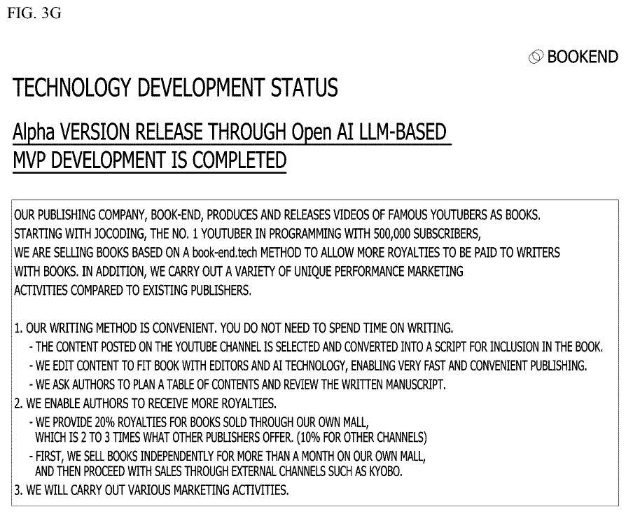

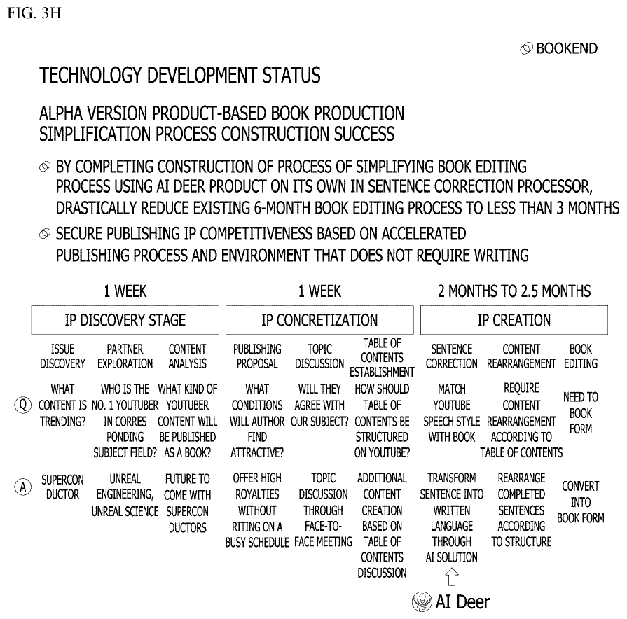

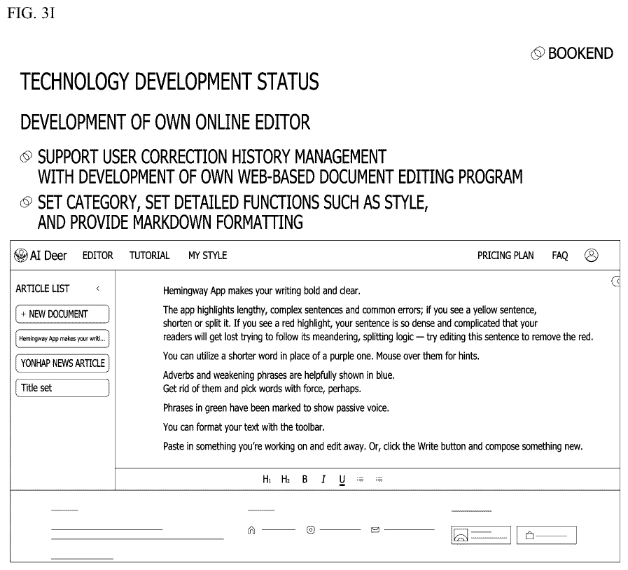

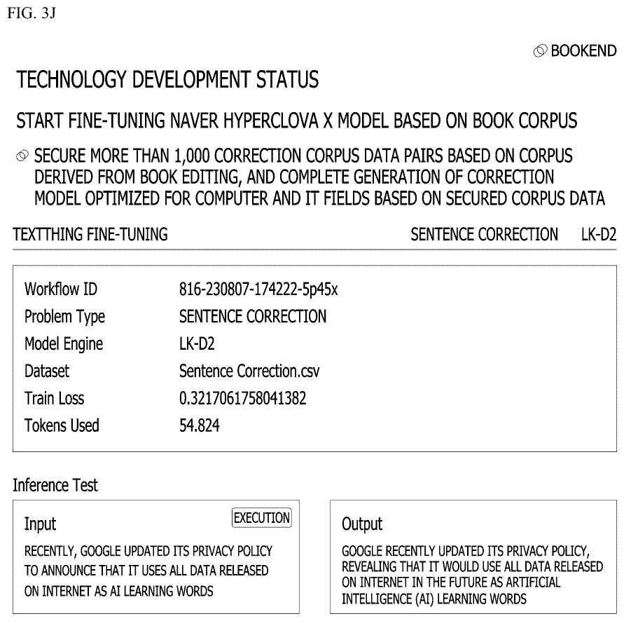

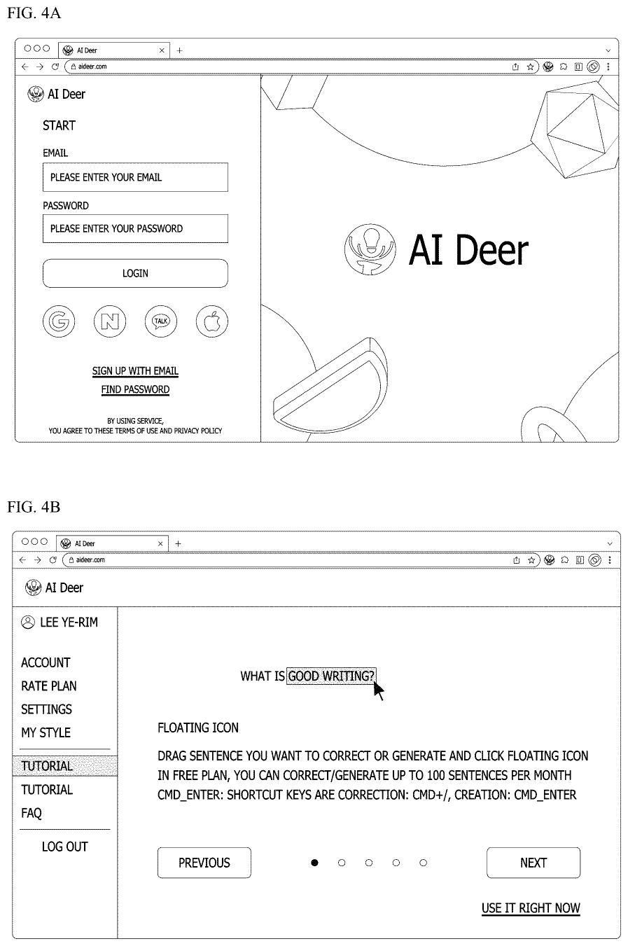

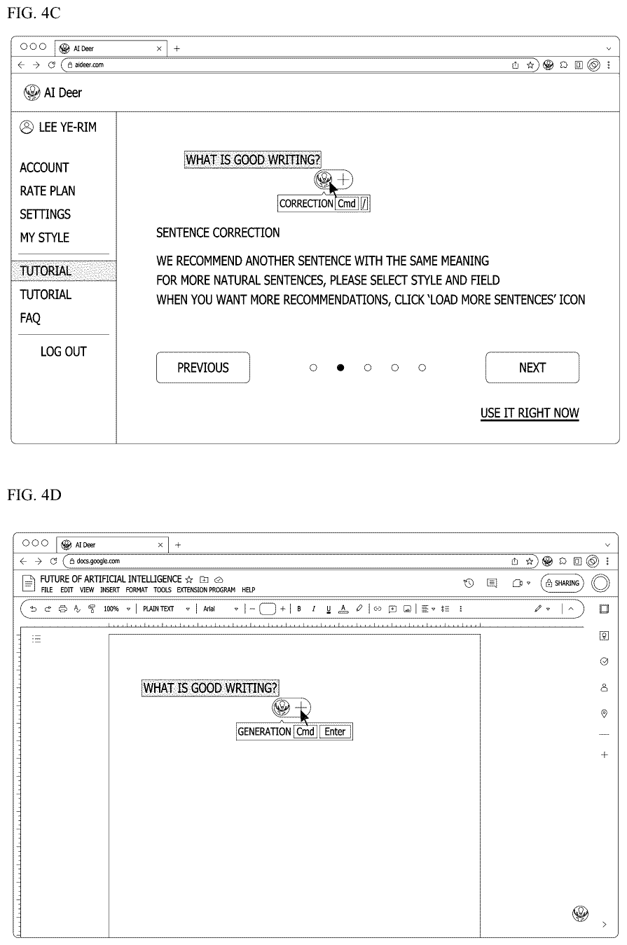

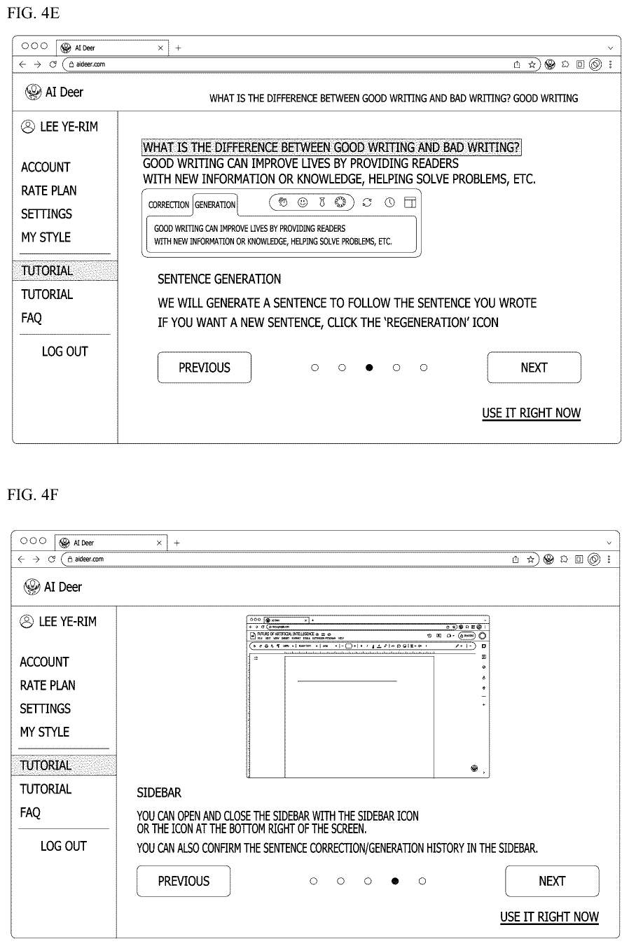

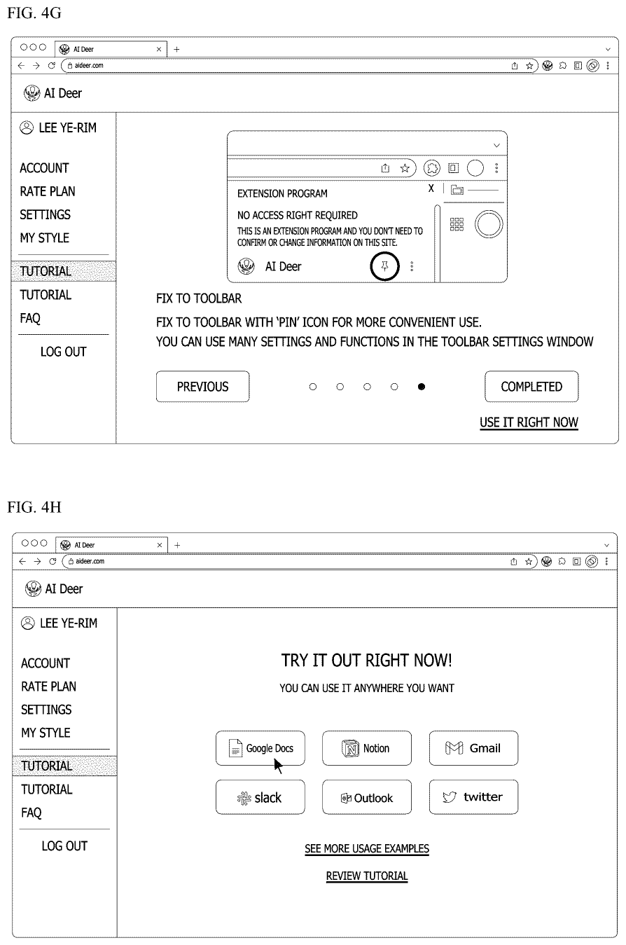

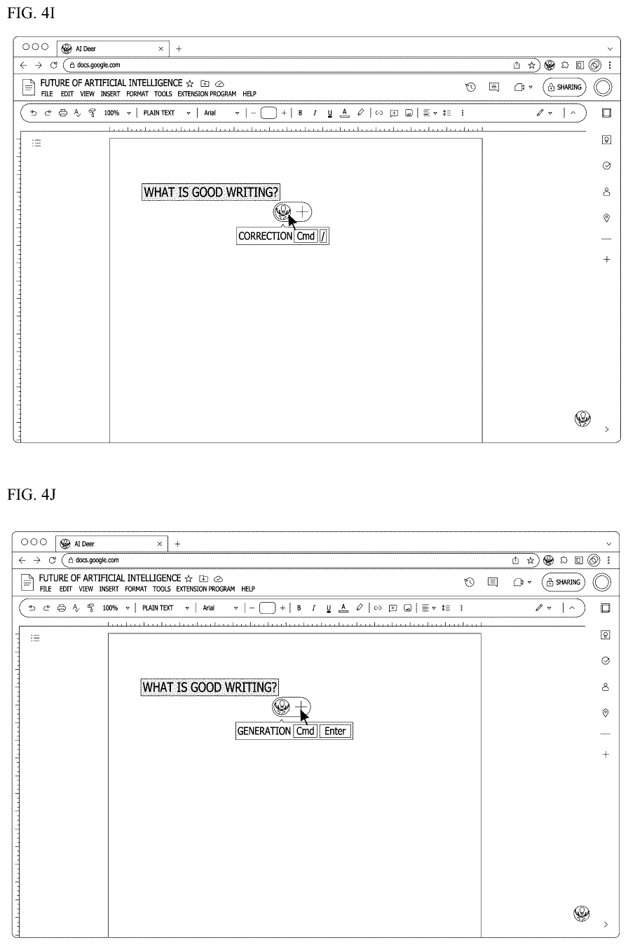

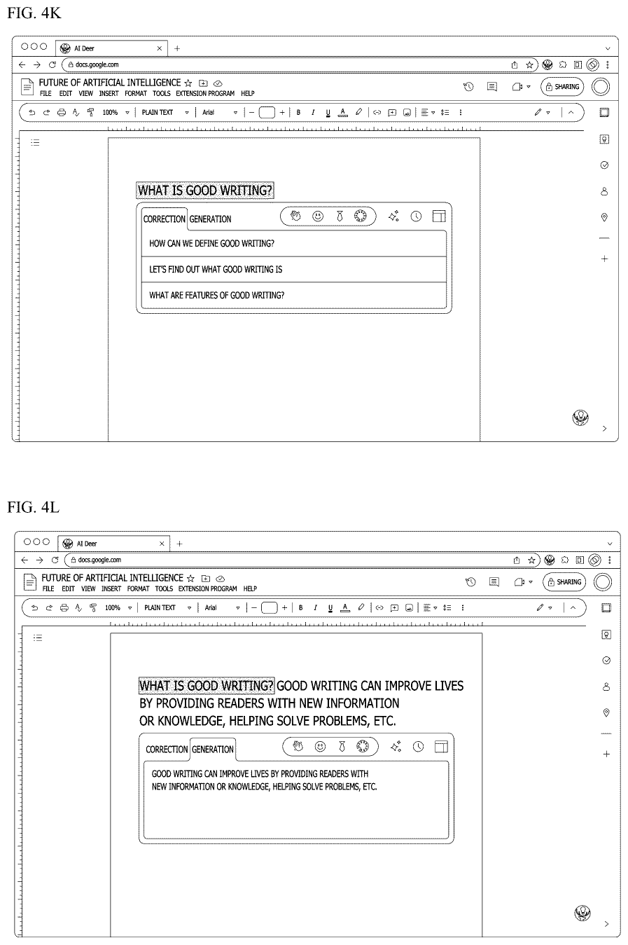

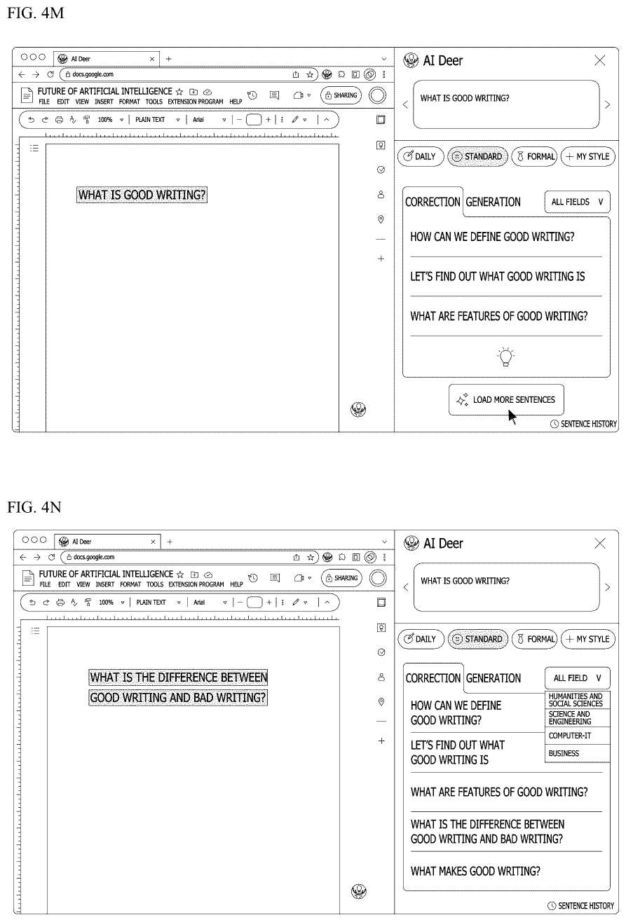

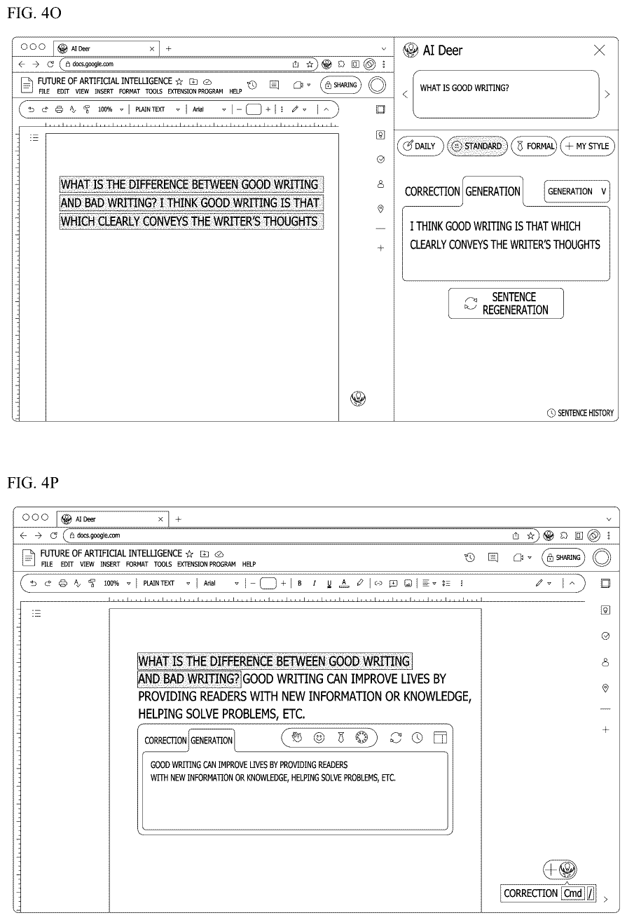

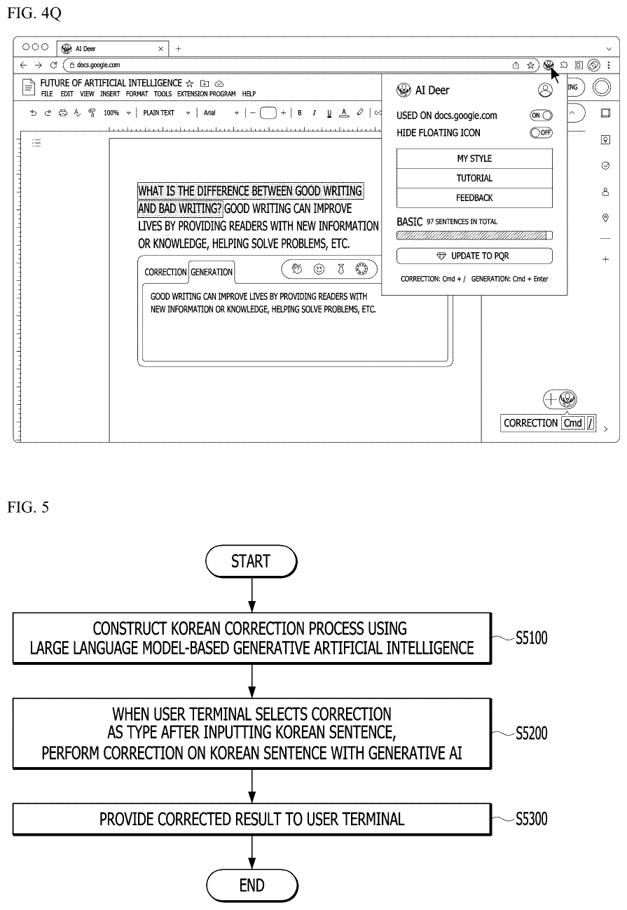

FIG. 2 is a block diagram for describing a correction service providing server included in the system of FIG. 1, and FIGS. 3A to 3J and 4A to 4Q are diagrams for describing an embodiment in which Korean sentence correction services according to an embodiment of the present invention are implemented.

Referring to FIG. 2, the correction service providing server 300 may include a construction unit 310, a correction unit 320, a transmission unit 330, a generation unit 340, a standard provision unit 350, a tone field application unit 360, a correction history management unit 370, a tuning unit 380, a fining unit 390, and a provision format management unit 391.

When the correction service providing server 300 according to an embodiment of the present invention or another server (not illustrated) operating in connection with the correction service providing server 300 transmits the Korean sentence correction services-related application, program, app page, web page, etc., to the at least one user terminal 100 and the at least one model providing server 400, the at least one user terminal 100 and the at least one model providing server 400 may install or open the Korean sentence correction service-related application, program, app page, web page, etc. In addition, the service program may be driven in the at least one user terminal 100 and the at least one model providing server 400 using a script executed in a web browser. Here, the web browser is a program that enables the use of WWW services, and is a program that receives and displays hypertext written in Hyper Text Mark-up Language (HTML), and includes, for example, Chrome, Microsoft Edge, Safari, FireFox, Whale, UC browser, etc. In addition, the application is an application on a terminal, and includes, for example, an app executed in a mobile terminal (smartphone).

Referring to FIG. 2, the construction unit 310 may construct a Korean language correction process using the LLM-based generative AI. The LLM is a large-scale language model that trains on vast amounts of data and has more than hundreds of billions of parameters. The LLM is trained with large-scale text data and may acquire various types of language phenomena and knowledge, and therefore the LLM may have a high understanding of natural language and also generate new sentences. In addition, the LLM may be additionally trained to deal with specific tasks and domains based on a basic language model. More parameters mean that the LLM is larger. The parameters are various variables that AI considers for calculations, and the more parameters there are, the more information the LLM may train from data. The larger model size means that the language model may have more information, which means that the accuracy may be improved. In order to train the LLM, it is very difficult to configure an environment for constructing the LLM because a high-performance computing device, such as a graphics processing unit (GPU), and a storage device for managing a large amount of data are required. As described above, despite the development of the LLM, it is not easy to directly develop or operate models due to enormous computing resources. Due to these characteristics, the development of open source-based LLM projects has been slow, but recently, with the development of various lightweight techniques, models of various sizes, from large-scale server-based models to desktop-level models, have been studied.

### Generative AI

Among generative AI, text AI may include ChatGPT. In this case, there are various types of generative AI. Generative AI also has various fields such as text AI that generates text, image AI that generates images, audio AI that generates audio, and video AI that generates video. Generative AI, which answers questions like a human by applying the above-described LLM, is being introduced into various fields. The leader among generative AI-based chatbots is none other than OpenAI's ChatGPT. ChatGPT is a natural language generation model developed by OpenAI. It is a model that has been trained to be able to converse like a human by training on large amounts of text data related to conversation. Among these, the transformer model is a deep learning technology that is effective in natural language processing, and the transformer model is a self-attention that trains context and meaning by tracking the relationship within sequential data in a sentence. The neural network uses an evolutionary mathematical technique to detect even a portion where the meaning of data elements separated from each other changes depending on the relationship.

While general deep learning-based AI technology simply predicts or classifies based on the existing data, the generative AI is a more advanced AI technology that actively presents results such as data or content based on data that is found and trained on its own to deal with questions or tasks that users request. AI developers are developing and applying various generative AI models depending on the purpose of services they want to develop, and the generative AI model most widely used in chatbot services such as ChatGPT is the LLM described above. To put it simply, the LLM is the generative AI model that trains on language data such as text and provides results. The LLM applied to ChatGPT developed by OpenAI is a GPT, and ChatGPT-4, which has a model size approximately 500 times larger than the existing model GPT 3.5, was released in March 2023. In addition, Google has published Bard that is a chatbot service utilizing Pathways Language Model (PaLM) (Google's LLM), and Meta has published an LLM called Large Language Model Meta A (LLaMA) (Meta's LLM). In Korea, Naver has developed OCEAN (NAVER's LLM) that is a super-large language model specializing in Korean and has released HyperclovaX that is an OCEAN-based chatbot service. An embodiment of the present invention may use OpenAI, HyperclovaX, Bard, etc., but is not limited thereto, and it is obvious that even an LLM that is not listed may be used according to an embodiment of the present invention.

The correction unit 320 may correct Korean sentences using the generative AI when the user terminal 100 inputs the Korean sentences and then selects correction as a type. The user terminal 100 may input the Korean sentences and select a type corresponding to the correction or generation of the Korean sentences. Since a database is accumulated for corpus pairs before and after correction, a platform according to an embodiment of the present invention may use the corpus pairs. However, a process of organizing the corpus pairs so that the system can understand the corpus pairs may be required. For example, the platform according to an embodiment of the present invention may publish a YouTuber's video as a book. In this case, speech utterances spoken by YouTubers in their videos are spoken language, but when published as a book, should be changed to written language. The correction that changes tone in this way is necessary. In an embodiment of the present invention, the YouTuber's speech utterances may be changed to written language through the flow of [video-speech utterance extraction-text-to-speech (TTS)-tone correction]. When a speech utterance is changed to written language in this way, it is possible to significantly reduce the manpower and time required to watch a YouTuber's videos one by one and transcribe the videos, and then convert the videos back into written language.

### Text Style Transfer

A text style transfer is a task of changing a style of an input sentence while maintaining content of the sentence. When there is sufficient parallel data for the text style transfer, a general machine translation model may be used. However, since the parallel data for the text style transfer is generally insufficient, the focus is on an unsupervised approach. In an embodiment of the present invention, a method of automatically constructing a parallel corpus composed of spoken language-written language pairs by converting spoken language into written language style may also be used. First, after collecting the spoken language sentences, a spoken language-written language parallel corpus may be automatically constructed using round-trip translation (a process of translating text into other languages and then translating the result back to the original language), and incorrect sentence pairs may be automatically filtered out from an initial parallel corpus. In addition, a [spoken language-written language] translation dictionary may be automatically constructed from the constructed parallel corpus to verify the constructed parallel corpus.

### Spoken Language Text Summarization

The text style transfer described above may be used, but in the case of YouTube, books tend to include unnecessary content. Accordingly, to remove the unnecessary content, a method of summarizing spoken language and then converting the summarized spoken language into written language may also be used. Automatic text summarization technology for summarization may be divided into extractive summarization, which combines words extracted from the text, and abstractive summarization, which creates sentences using new words not used in the text. The extractive summarization, which is a relatively simple method compared to the abstractive summarization, is a method of assigning a score to each sentence in a document and summarizing the sentence with the highest score, and the abstractive summarization reinterprets the original and generates a summary with different expressions from the text, and is excellent in performance because it is more suitable for reality than the extractive summarization even if it is more complex than the extractive summarization. Models used for the extractive summarization include SummaRu-NNNer, NeuSum, BERTSum, etc., and models used for the abstractive summarization include BERTSumAbs and BERTSumExtAbs models, etc. This is structurally identical to BERTSum but has a structure that includes a decoder instead of a transformer encoder. However, the largest difference between the two models is that the BERTSumExtAbs model performs fine-tuning twice. The encoder that has trained the extractive summarization trains the task for the abstractive summarization once again. The performance of the BERTSumExtAbs, which first trains the extractive summarization in two steps and then performs the abstractive summarization, is more excellent than the BERTSumAbs directly performing the abstractive summarization. Accordingly, in an embodiment of the present invention, the abstractive summarization may be used instead of the extractive summarization. The extractive summarization is useful when it is important to convey the original content as it is, but the automatic summarization function, which is evaluated to be closer to human language ability, may be called the abstractive summarization. Of course, it does not exclude the use of the extractive summarization.

The transmission unit 330 may provide the corrected result to the user terminal 100. When the correction is selected, the user terminal 100 may output the corrected result of the Korean sentences.

When the generation is selected as the type in the user terminal 100, the generation unit 340 may generate the next sentence of the sentence input from the user terminal 100 and then provide the generated sentence to the user terminal 100. In addition to the correction described above, the next Korean sentence following the input Korean sentence may be requested using the generative AI described above, and the generation unit 340 may provide the following sentence.

The standard provision unit 350 may use a correction corpus data pair based on the corpus accumulated in book editing in order to provide the correction. In addition to the corpus accumulated in the book editing, a spelling correction corpus among all corpora (https://corpus.korean.go.kr/) provided by the National Institute of Korean Language may be additionally used, or the results of the ChatGPT corpus project currently in progress may be used.

The tone field application unit 360 may correct Korean sentences according to the tone and field selected in the user terminal 100. In this case, the tone may be, for example, formal, daily, standard, etc., as illustrated in FIG. 4O, and the field may be, for example, humanities and social sciences, science and engineering, computer IT, business, etc., as illustrated in FIG. 4N, but it is not limited to the listed ones and nothing is excluded for any reasons not listed. This may also be used to correct Korean sentences using the generative AI trained from corpora accumulated in formal, daily, standard, etc., and a corpus accumulated in each field. Even for the same word, there may be differences in terms used in each field, so sentences may be generated or corrected appropriately for each field so that terms in each field may be used well according to the context.

The correction history management unit 370 may store, as the correction data, the results selected from the user terminal 100 among the corrected results in the correction history. The tuning unit 380 may perform human-in-the-loop (HITL) machine learning that reinforces the generative AI using correction data.

The tuning unit 380 may further apply a continuous learning-based model that may train the user's correction data. The continuous learning-based model may be composed of a task manager, user attribute extraction, and an auto-growing knowledge graph. When the task manager discovers new data from feedback with users, it generates a new task using previously trained knowledge. The user feature extraction model extracts user characteristics from new tasks, and the auto-growing knowledge graph enables continuous learning of new external knowledge. The continuous learning-based model with continuous learning technology enables customized responses as the user feedback accumulates.

### Continuous Learning

Human knowledge builds up and becomes enriched with more information over time. However, when training a new task, an artificial neural network exhibits a phenomenon of forgetting previous tasks. This phenomenon is called catastrophic forgetting, and the continuous learning focuses on solving the problem of catastrophic forgetting. Catastrophic forgetting is a phenomenon in which training each new task is highly likely to change the weight of a previously trained task and reduce the model accuracy of the previous task. The continuous learning gradually trains tasks in order, and each task is composed of a set of tasks to be trained. The continuous learning has various classification methods depending on the approach, and may be classified into rehearsal methods, regularization methods, architecture methods, and hybrid methods that use a mixture of two or more methods.

### Rehearsal Method

The rehearsal method involves storing raw samples as memories of past tasks. These samples are played while training a new task to alleviate forgetting. This method is also expressed as a memory-based method. Examples of the method include an iCaRL model, which is the most well-known method for incremental class learning. This model samples previous data to construct and utilize a core set. The core set may be used not only for playing new data during the training process, but also for regularization purposes. The core set may be used to regularize gradients when training a new task, as in GEM and A-GEM. Although the rehearsal method is prone to overfitting to a subset of stored samples and may appear to be constrained by joint training, the constrained optimization is an alternative solution that is freer in terms of transmission.

### Regularization Method

Continuous learning models should not be overfitted to new problems because they may forget previous technologies. The regularization approaches in the continuous learning introduce additional regularization in the loss function to maintain the memory of the previous knowledge, thereby integrating the previous knowledge when training new data. Regularization methods may be divided into a data-focused method and a prior-focused method. The data-focused method distills knowledge from previous models to new data-trained models to integrate the previously trained knowledge. This was introduced to transfer knowledge in a teacher-student model, which means that after a teacher model is trained to solve a problem, a student model wants to share the skills with the teacher model. Thereafter, the two models are given the same input and both have the same output. The distillation is more efficient than retraining the student model because it creates a soft target that helps the student model train faster.

### Architecture Method

The architecture method generally assigns different model parameters to different tasks so that subsequent tasks do not interfere with previously trained knowledge. Typically, the parameters of the previous task are kept fixed. The architecture method dynamically changes the network architecture to assign parameters of different models to different tasks. This prevents the catastrophic forgetting problem by applying modular changes to the network architecture and introducing task-specific parameters. Implicit architecture modification adapts the model for the continuous learning without modifying the architecture. Typically, the adaptation is done by changing a forward pass path or disabling some learning devices. The method of dynamically freezing weights is classified as the implicit architecture. Since the architecture of the model does not change, it is implicit, but the performance of the model may vary greatly. Of course, it is obvious that it is not limited to the above-described method and that it can identify the user's preference in various ways and provide customized services to the user.

### User Attribute Extraction and Auto-Growing Knowledge Graph

For the user attribute extraction, data may be gradually trained using newly obtained correction data through feedback. The stored data includes the user's selected tone, classification, and correction method (correction data), and this enables the generative AI to provide personalized services that are similar to those actually corrected or created by the user. The knowledge obtained in this way is stored as the knowledge graph. The auto-growing knowledge graph may be composed of a knowledge learner, a knowledge miner, and an expansion in that order. The knowledge learner collects data by crawling external data in real time to obtain knowledge that was not known in the conversation. The meaning of the acquired knowledge or data is captured so that the acquired knowledge may be used together for the current and future learning of the generation-based chatbot. In the knowledge miner stage, new relationships are extracted for constructing the auto-growing knowledge graph. Finally, the extension plays a role in inferring new facts from existing facts and connecting newly discovered relationships to the existing knowledge graph. Through this process, natural correction or generation is possible even when unknown facts appear in the user's Korean sentences. This may be complementarily connected to the knowledge graph.

The fining unit 390 may accumulate correction data to construct a database and perform LLM fine-tuning. The LLM has limitations in constructing a model from scratch due to resources such as the large-scale text data collection, the data preprocessing, the large-scale computing, the time, etc. Therefore, the pretrained model pretrained from a vast amount of text is used as a foundation model and is fine-tuned to create a fine-tuned model. The foundation model is a model that has been pretrained with large amounts of data and designed to be used for specific processing tasks without additional training. Representative pretrained models include Bidirectional Encoder Representations from Transformers (BERT), GPT, and LLaMA, and the fine-tuned models include Alpaca and Vicuna. The method of fine-tuning a model is to additionally train a model for a specific purpose by utilizing separate tasks and domain data. It uses a Parameter-Efficient Fine-Tuning LLAMA2 (PEFT LLAMA2) technique such as Low-Rank Adaptation (LoRA) to fine-tune using few computing resources.

By utilizing this fine-tuning technique, the LLM that may be applied in various fields at a relatively low cost may be created.

The provision format management unit 391 may provide the Korean correction process in a modal format that runs in a browser environment. It may be provided as an extension program, for example, a Chrome extension program, and the Chrome extension program has been provided in the Chrome web store (https://chrome.google.com/webstore/detail/ai-deer/clfeejjmcegnmnhoaaffboddkajhenep?hl=ko)

Hereinafter, an operation process according to the configuration of the correction service providing server of FIG. 2 will be described in detail with reference to FIGS. 3A to 3J and 4A to 4Q as an example. However, it will be apparent that the embodiment is only one of various embodiments of the present invention and is not limited thereto. Referring to FIGS. 3A and 3B, a platform according to an embodiment of the present invention may be provided as an extension program in a user's online writing environment, uses an application programming interface (API) gateway method that may use multiple LLMs, and enables the HITL machine learning using the user's correction data. As illustrated in FIG. 3C, when a user selects or inputs a sentence to be corrected, the correction service providing server 300 requests member information or credits and then requests correction from the LLM, and when the correction is delivered, provides the correction to the user terminal 100, and stores the sentence selected by the user as correction data and databases the correction data so that the HITL machine learning and the fine-tuning are possible. The user flowchart may be organized as illustrated in FIG. 3D. The API structure includes sentence correction, sentence generation, sentence history management, etc., as illustrated in FIG. 3E. Currently, as illustrated in FIGS. 3F and 3G, an alpha version of an OpenAI-based Korean sentence correction process has been released, and as illustrated in FIG. 3H, a simplified process for producing a YouTuber's video into a book has been successfully established. We developed our own online editor as illustrated in FIG. 3I and started fine-tuning the Naver HyperCLOVA X model based on a book corpus as illustrated in FIG. 3J.

### Test

When the solution (tentative name, AI Deer) according to an embodiment of the present invention is started as illustrated in FIG. 4A, the tutorial is performed as illustrated in FIGS. 4B and 4C, and the correction or generation of Korean sentences is possible with a floating icon in the online editor as illustrated in FIG. 4D. In the case of the generation, it plays a role in generating the next sentence of the Korean sentence presented as illustrated in FIG. 4E, and the correction or generation history of the sentence may be confirmed in a sidebar as illustrated in FIG. 4F. As illustrated in FIG. 4G, the solution according to one embodiment of the present invention may be fixed to a toolbar, and as illustrated in FIG. 4H, may be used anywhere in the online environment. As illustrated in FIGS. 4I and 4J, when a Korean sentence [What is good writing?] is written in Google Docs, i.e., an online editor, and then the correction is requested as illustrated in FIG. 4K, the corrected sentence is presented at the bottom, and when the generation is requested, the next sentence is presented at the bottom as illustrated in FIG. 4L. As illustrated in FIG. 4M, the sidebar allows a tone to be selected and more sentences to be loaded, and a field can also be selected as illustrated in FIG. 4N. Similarly, a tone and field may be generated as illustrated in FIG. 4O, and a tone may also be selected from a floating icon in FIG. 4P. As illustrated in FIG. 4Q, which webpage to use can be set with a toggle button.

Matters not described in the method of providing Korean sentence correction services of FIGS. 2, 3A to 3J and 4A to 4Q are the same as those described with reference to the method of providing Korean sentence correction services in FIG. 1 or can be easily derived from the described content, and therefore description thereof will be omitted below.

FIG. 5 is a diagram illustrating a process in which data is transmitted/received between respective components included in the system for providing Korean sentence correction services of FIG. 1 according to the embodiment of the present invention. Hereinafter, an example of the process of transmitting/receiving data between the respective components will be described with reference to FIG. 5, but the present application is not limited to such an embodiment, and it is apparent to those skilled in the art that the process for transmitting and receiving data illustrated in FIG. 5 may be changed according to various embodiments described above.

Referring to FIG. 5, the correction service providing server constructs the Korean correction process using the LLM-based generative AI (S5100), and when the Korean sentence is input from the user terminal and correction is selected as the type, performs the correction on the Korean sentence using the generative AI (S5200).

Then, the correction service providing server provides the corrected result to the user terminal (S5300).

The order between the above-described operations (S5100 to S5400) is merely an example and is not limited thereto. That is, the order between the above-described operations (S5100 to S5400) may be mutually changed, and some of these operations may be simultaneously executed or deleted.

Matters not described in the method of providing Korean sentence correction services of FIG. 5 are the same as those described with reference to the method of providing Korean sentence correction services in FIGS. 1, 2, 3A to 3J and 4A to 4Q or can be easily derived from the described content, and therefore description thereof will be omitted below.

The method of providing Korean sentence correction services according to the embodiment described with reference to FIG. 5 may be implemented in the form of a recording medium including instructions executable by a computer, such as an application or program module executed by a computer. A computer-readable medium may be any available medium that may be accessed by a computer and includes both volatile and nonvolatile media and removable and non-removable media. In addition, the computer-readable medium may include all computer storage media. The computer storage medium includes both volatile and nonvolatile and removable and non-removable media implemented in any method or technology for storage of information such as computer readable instructions, data structures, program modules, or other data.

The method of providing Korean sentence correction services according to the embodiment of the present invention described above may be executed by an application (which may include programs included in a platform, an operating system, or the like basically installed in the terminal) that is basically installed in the terminal, and may be executed by an application (i.e., a program) installed directly on a master terminal by a user through an application providing server such as an application store server, an application, or a web server related to the corresponding service. In this sense, the method of providing Korean sentence correction services according to the embodiment of the present invention described above is implemented as an application (i.e., program) basically installed in a terminal or directly installed by a user and may be recorded on a computer-readable recording medium of the terminal, or the like.

According to any one of the above-described problem solving means of the present invention, it is possible to construct an LLM-based generative AI to correct or generate the Korean sentences, when the tone and field of the sentence are specified, correct or generate the sentences to correspond to the specified tone and field, perform HITL machine learning using the user's correction data after storing and managing the sentence correction history, fine-tune the LLM by using the accumulated correction data, and provide the LLM as the extension program so that it can be used in the online environment.

The description of the present invention provided above is illustrative, and it is to be understood by those skilled in the art that various modifications and alterations may be made without departing from the spirit or essential features of the present invention. Therefore, it is to be understood that the exemplary embodiments described above are illustrative rather than being restrictive in all aspects. For example, respective components described as a single form may be implemented in a distributed manner, and similarly, components described as being distributed may also be implemented in a combined form.

It should be interpreted that the scope of the present invention is defined by the following claims rather than the above detailed description and all modifications or alterations deduced from the meaning, the scope, and equivalences of the claims are included in the scope of the present invention.

What is claimed is:

1. A system for providing Korean sentence correction services, comprising:
a user terminal that inputs a Korean sentence, selects a type corresponding to correction or generation of the Korean sentence, and outputs corrected results of the Korean sentence when the correction is selected; and
a correction service providing server including a construction unit that constructs a Korean correction process using large language model (LLM)-based generative artificial intelligence (AI), a correction unit that performs correction on the Korean sentence using the generative AI when the user terminal selects the correction as the type after inputting the Korean sentence, a transmission unit that provides the corrected results to the user terminal, a correction history management unit that stores, as correction data, a result selected by the user terminal among the corrected results in the correction history, a tuning unit that performs human-in-the-loop (HITL) machine learning to reinforce the generative AI using the correction data, and a fining unit that accumulates the correction data to construct a database and perform fine-tuning of the LLM,
wherein the correction service providing server performs correction to change a speech utterance, which is spoken language spoken in a YouTuber's video, into written language for publishing as a book, and changes the YouTuber's speech utterance into written language through a flow of the video, speech utterance extraction, text-to-speech (TTS), and tone correction,
summarizes the spoken language corresponding to the speech utterance in the video, and then summarizes spoken language text through abstractive summarization of reinterpreting an original to generate a summary with different expressions from main text, which is a method of converting the summarized spoken language into the written language, in order to remove unnecessary content included in the video, and
is provided as an extension program in a user's online writing environment, uses an application programming interface (API) gateway method that uses multiple LLMs, and performs HITL machine learning using correction data of the user.

2. The system of claim 1, wherein the correction service providing server further includes a generation unit that generates a next sentence of the sentence input from the user terminal and then provides the generated next sentence to the user terminal when the user terminal selects generation as the type.

3. The system of claim 1, wherein the correction service providing server further includes a standard provision unit that uses correction corpus data pairs based on a corpus accumulated in book editing to provide the correction.

4. The system of claim 1, wherein the correction service providing server further includes a tone field application unit that corrects the Korean sentence according to a tone and field selected in the user terminal.

5. The system of claim 1, wherein the correction service providing server further includes a provision format management unit that provides the Korean correction process in a modal format running in a browser environment.
